(19) United States
(12) Patent Application Publication
(10) Pub. No.: US 2024/0246468 A1
(43) Pub. Date: Jul. 25, 2024

(54) MOBILE OBJECT CONTROL SYSTEM AND MOBILE OBJECT CONTROL METHOD

(71) Applicant: TOYOTA JIDOSHA KABUSHIKI KAISHA, Toyota-shi (JP)

(72) Inventor: Takanobu NASU, Sagamihara-shi (JP)

(73) Assignee: TOYOTA JIDOSHA KABUSHIKI KAISHA, Toyota-shi (JP)

(21) Appl. No.: 18/489,957

(22) Filed: Oct. 19, 2023

(30) Foreign Application Priority Data
Jan. 23, 2023 (JP) 2023-007908

(51) Int. Cl. B60N 2/90

(52) U.S. Cl. CPC B60N 2/90; B60N 2002/981

(57) ABSTRACT

A mobile object control system includes a plurality of backrest portions, a plurality of vibrating portions, a prediction unit, and a drive control unit. The backrest portions are arranged side by side in the lateral direction so as to be able to support the back of an occupant on the mobile object. The vibrating portion is provided on each of the plurality of backrest portions. The prediction unit predicts acceleration occurring in the mobile object.

Based on the predicted acceleration, the drive control unit drives the vibrating portion before acceleration occurs. The drive control unit varies the vibration amounts of the plurality of vibrating portions according to the direction of the predicted acceleration.

### CROSS-REFERENCE TO RELATED APPLICATION

This application claims priority to Japanese Patent Application No. 2023-007908 filed on Jan. 23, 2023, incorporated herein by reference in its entirety.

### BACKGROUND

### 1. Technical Field

The present disclosure relates to a technology for controlling a mobile object where a person can get on and off.

### 2. Description of Related Art

Japanese Unexamined Patent Application Publication No. 2000-155893 (JP 2000-155893 A) discloses an information notification device including route search means, route guidance means, a vibrator, and control means. The route search means searches for and selects a route to a destination set by an operation unit. The route guidance means causes a mobile object to travel along the route selected by the route search means and guides the mobile object to the destination. The vibrator vibrates mechanically. The control means vibrates the vibrator when the route guidance means performs route guidance. This vibrator is provided on a steering wheel.

In the information notification device disclosed in JP 2000-155893 A, the vibrator is provided on the steering wheel. Only a driver is notified by the vibration of the vibrator and the target of notification does not include other occupants. Each occupant may lose balance depending on driving operation of the mobile object during travel.

### SUMMARY

It is an object of the present disclosure to provide a technology capable of notifying each occupant in advance about driving operation of a mobile object.

In order to solve the above problem, a mobile object control system according to one aspect of the present disclosure includes:
a plurality of backrest portions configured to support backs of occupants riding on a mobile object and arranged in a lateral direction or a longitudinal direction;
a plurality of vibrating portions provided for the individual backrest portions;
a prediction unit configured to predict an acceleration expected to occur in the mobile object; and
a drive control unit configured to drive the vibrating portions based on the predicted acceleration before the acceleration occurs.
   The drive control unit is configured to vary vibration amounts of the vibrating portions based on a direction of the predicted acceleration.

Another aspect of the present disclosure relates to a mobile object control method. This method is
a mobile object control method for controlling a mobile object including a plurality of backrest portions configured to support backs of occupants riding on the mobile object and arranged in a lateral direction or a longitudinal direction, and a plurality of vibrating portions provided for the individual backrest portions. The mobile object control method includes:
a step of predicting an acceleration expected to occur in the mobile object; and
a step of driving the vibrating portions based on the predicted acceleration before the acceleration occurs.
   The step of driving includes varying vibration amounts of the vibrating portions based on a direction of the predicted acceleration.

According to the present disclosure, it is possible to provide the technology capable of notifying each occupant in advance about the driving operation of the mobile object.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a top view of a mobile object of an embodiment;

FIG. 1B is a side view of a mobile object of an embodiment;

FIG. 2 is a diagram showing the functional configuration of the mobile object control system;

FIG. 3 is a flowchart of vibration generation processing for driving the vibrating portion to notify the passenger of the operation of the mobile object; and

FIG. 4 is a perspective view of a mobile object of a modified example.

### DETAILED DESCRIPTION OF EMBODIMENTS

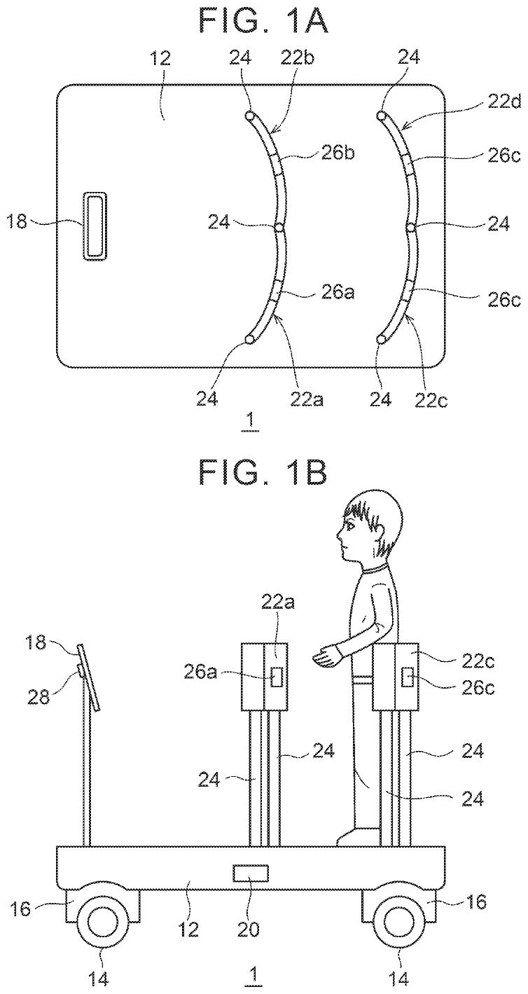

FIG. 1A is a top view of a mobile object 1 of an embodiment. FIG. 1B is a side view of the mobile object 1 of the embodiment. FIG. 1B shows a state in which an occupant is on the mobile object 1. The mobile object 1 can automatically run.

The mobile object 1 includes a vehicle body 12, wheels 14, a travel device 16, a display input unit 18, a control device 20, a first backrest portion 22a, a second backrest portion 22b, a third backrest portion 22c, and a fourth backrest portion 22d (when not distinguished, they will be referred to as the “backrest portion 22”), the support portion 24, the first vibrating portion 26a, the second vibrating portion 26b, the third vibrating portion 26c, and the fourth vibrating portion 26d (when not distinguished, they will be referred to as the “vibrating portion 26”), and an on-board sensor 28.

The vehicle body 12 has a pedestal formed in a substantially flat plate shape, and can carry a plurality of passengers. The vehicle body 12 is large enough to accommodate four passengers, for example. The wheels 14 are four wheels. The direction along the axle of the wheel 14 is called the lateral direction. The travel device 16 has a motor that rotates the wheels 14, a steering device that steers the wheels 14, and a braking device that stops the rotation of the wheels 14. The travel device 16 is driven and controlled by a control device 20. A battery is accommodated in the vehicle body 12 and the travel device 16. Since the vehicle body 12 does not have a door, it is easy for passengers to get on and off. An occupant can get on the mobile object 1 even when the mobile object 1 is running.

The display input unit 18 is a touch-input capable display that displays information to the occupant and accepts input from the occupant. A passenger can input the destination of the mobile object 1 to the display input unit 18.

The backrest portion 22 supports the back of the occupant and prevents the occupant from falling or falling while the mobile object 1 is running. The first backrest portion 22a is located on the front left side. The second backrest portion 22b is located on the front right side. The third backrest portion 22c is located on the rear left side. The fourth backrest portion 22d is located on the rear right side. The first backrest portion 22a and the second backrest portion 22b are arranged side by side. The third backrest portion 22c and the fourth backrest portion 22d are arranged side by side. The first backrest portion 22a and the second backrest portion 22b, and the third backrest portion 22c and the fourth backrest portion 22d are arranged in the longitudinal direction.

The plurality of support portions 24 are formed in a columnar shape and stand upright from the vehicle body 12. The backrest portion 22 is supported by a pair of support portions 24, respectively.

The vibrating portion 26 is built in each of the plurality of backrest portions 22. Driving of the vibrating portion 26 is controlled by the control device 20. The first vibrating portion 26a vibrates the first backrest portion 22a. The second vibrating portion 26b vibrates the second backrest portion 22b. The third vibrating portion 26c vibrates the third backrest portion 22c. The fourth vibrating portion 26d vibrates the fourth backrest portion 22d.

The vibrating portion 26 can set the amount of vibration steplessly or in multiple steps, and can change the amount of vibration. The amount of vibration of the vibrating portion 26 may be a value determined by the vibration amplitude and the vibration intensity, and may be either the vibration amplitude or the vibration intensity. In any case, the greater the amount of vibration of the vibrating portion 26, the more strongly the backrest portion 22 vibrates.

Mounted sensors 28 include a running state detection sensor that detects the running state of mobile object 1 and a running environment detection sensor that detects the running environment of mobile object 1. The running state detection sensor includes a sensor that detects the speed, acceleration, steering angle, and the like of the mobile object 1. The driving environment detection sensor includes a camera, an optical radar, a sound wave sensor, etc. that detect objects around the mobile object 1.

In addition, although the mobile object 1 of an Example shows the aspect which a passenger stands and gets on, it is not restricted to this aspect. For example, the mobile object 1 may be provided with a chair on which the passenger can sit. In any case, backrest portions 22 are provided on the left, right, front, and rear sides, respectively.

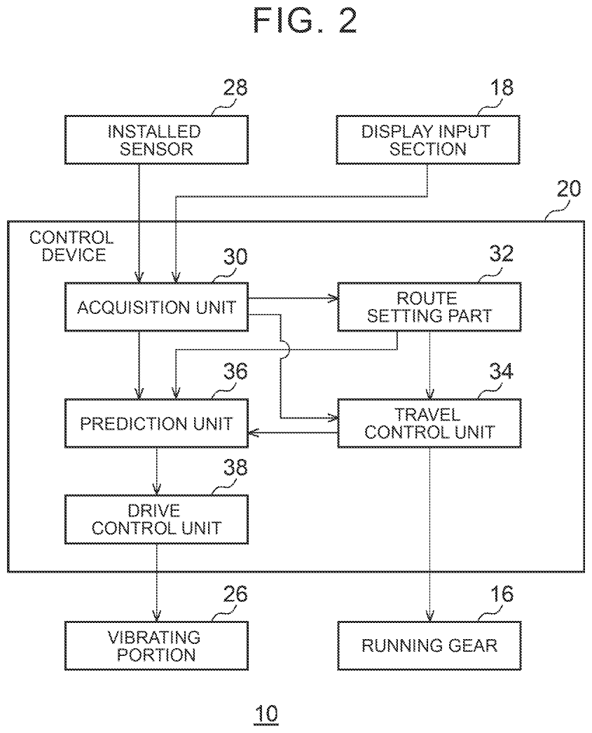

FIG. 2 shows a functional configuration of the mobile object control system 10. In FIG. 2, each element described as a functional block that performs various processes can be configured by circuit blocks, memories, and other LSIs in the case of hardware. In the case of software, each element is implemented by a program or the like loaded into memory. Therefore, those skilled in the art will understand that these functional blocks can be realized in various forms by hardware only, software only, or a combination thereof, and are not limited to either one.

The mobile object control system 10 is mounted on the mobile object 1, but may include an external server device. For example, the mobile object control system 10 may be capable of communicating with a server device via a network. A server device executes a part of arithmetic processing.

The mobile object control system 10 includes a travel device 16, a display input unit 18, a control device 20, a vibrating portion 26 and a mounted sensor 28. The control device 20 has an acquisition unit 30, a route setting unit 32, a travel control unit 34, a prediction unit 36 and a drive control unit 38.

The acquisition unit 30 periodically acquires detection results from the mounted sensor 28. The acquisition unit 30 acquires the input result from the display input unit 18. Note that the acquisition unit 30 may acquire information from an external server device or a passenger's mobile terminal device. For example, the acquisition unit 30 may acquire information about the target travel route from an external server device. The acquisition unit 30 may acquire information about the destination from the passenger's mobile terminal device. Also, the acquisition unit 30 acquires the position information of the mobile object 1 using the global positioning satellite system.

The route setting unit 32 calculates a target travel route based on the destination input to the display input unit 18, the map information, and the position information of the mobile object 1. The route setting unit 32 sets the calculated target travel route. The travel control unit 34 controls the travel device 16 so that the mobile object 1 moves along the set target travel route. The target travel route is updated based on the position information of the mobile object 1. The route setting unit 32 may be provided in a navigation device separate from the control device 20.

The prediction unit 36 predicts future acceleration that will occur in the mobile object 1 based on the target travel route set by the route setting unit 32 and the speed of the mobile object 1. The prediction unit 36 predicts driving actions that may cause acceleration such as start, stop, and steering of the mobile object 1 based on the target travel route. The prediction unit 36 predicts the acceleration that will occur when the driving action is executed in the future. By referring to the target travel route, the prediction unit 36 can predict the right turn or left turn of the mobile object 1 and the starting and stopping of the mobile object 1. The acceleration predicted by the prediction unit 36 is a vector and includes direction. The prediction unit 36 may predict the acceleration that occurs in each of the backrest portions 22. During turning, the farther the backrest portion 22 is positioned from the turning center, the greater the acceleration.

Objects located around the vehicle include traffic signs, obstacles, and the like. The mobile object 1 stops in response to a signal or an obstacle, or steers to avoid the obstacle. Therefore, the prediction unit 36 predicts driving actions that may cause acceleration such as stopping and steering of the mobile object 1 based on information about objects located around the vehicle. The prediction unit 36 predicts the acceleration that occurs when executing the driving action.

Based on the acceleration predicted by the prediction unit 36, the drive control unit 38 drives the vibrating portion 26 before the acceleration occurs. For example, several seconds before the acceleration occurs. The drive control unit 38 determines to start driving the vibrating portion 26 when the predicted acceleration is greater than or equal to a predetermined threshold. The drive control unit 38 does not start driving the vibrating portion 26 when the predicted acceleration is smaller than a predetermined threshold.

The mobile object 1 does not have a door, and a passenger can easily get on it. Depending on the operation of the moving body 1, the occupant may lose balance and run off the moving body 1. Therefore, the mobile object control system 10 warns the passenger by vibrating the backrest portion 22 before a driving motion that causes a large acceleration is executed. As a result, the occupant receives vibrations from the backrest portion 22 and can prepare himself by grasping the backrest portion 22.

The drive control unit 38 varies the vibration amounts of the plurality of vibrating portions 26 according to the direction of acceleration predicted by the prediction unit 36. For example, when the mobile object 1 stops, the mobile object 1 is accelerated backward, and the occupant is accelerated forward. At this time, the drive control unit 38 makes the amount of vibration of the first vibrating portion 26a and the second vibrating portion 26b on the front side larger than that of the third backrest portion 22c and the fourth backrest portion 22d on the rear side. Accordingly, the occupant using the first backrest portion 22a and the second backrest portion 22b on the front side can prepare themselves so as not to fall forward. In this manner, the drive control unit 38 varies the amount of vibration of the front and rear vibrating portions 26 according to the direction of the predicted acceleration. The drive control unit 38 calculates the vibration amount of each of the plurality of vibrating portions 26. The drive control unit 38 drives the vibrating portion 26 with the calculated vibration amount until the acceleration becomes zero after starting to drive the vibrating portion 26.

The drive control unit 38 varies the vibration amounts of the plurality of vibrating portions 26 according to the direction and magnitude of the predicted acceleration. The drive control unit 38 increases the amount of vibration of the vibrating portion 26 as the predicted acceleration increases. As a result, the occupant can be warned in accordance with not only the direction of the acceleration but also the magnitude of the acceleration. The occupant can judge the degree of danger from the magnitude of the vibration amount.

The drive control unit 38 makes the vibration amount of the left vibrating portion 26 larger than that of the right vibrating portion 26 when the direction of the predicted acceleration is the right direction. The drive control unit 38 makes the vibration amount of the right vibrating portion 26 larger than that of the left vibrating portion 26 when the direction of the predicted acceleration is leftward. For example, when the mobile object 1 turns to the right, the mobile object 1 accelerates to the right, and the occupant receives a leftward force. At this time, the drive control unit 38 makes the vibration amounts of the first vibrating portion 26a and the third vibrating portion 26c on the left larger than those of the second vibrating portion 26b and the fourth vibrating portion 26d on the right. Since leftward force is applied to the occupant when the mobile object 1 turns right, the occupant positioned on the first backrest portion 22a and the third backrest portion 22c may be swung leftward and out of the vehicle body 12. On the other hand, even if the occupant positioned on the second backrest portion 22b and the fourth backrest portion 22d is swung to the left, there is little possibility that the occupant will move to the left side of the vehicle body 12 because of the presence of the first backrest portion 22a and the third backrest portion 22c. Therefore, when turning right, the occupant using the first backrest portion 22a and the second backrest portion 22b is warned by a strong vibration. Thereby, the magnitude of the warning can be appropriately set according to the riding position.

The mobile object 1 may make an emergency stop or abruptly turn to avoid obstacles. The prediction unit 36 predicts emergency driving actions including collision avoidance actions and emergency braking actions for reducing damage. The prediction unit 36 may acquire information indicating execution of the collision avoidance action from another driving support system. The prediction unit 36 may determine whether the driving action is urgent or not based on the magnitude of the predicted acceleration. When the prediction unit 36 determines that the mobile object 1 will perform an emergency driving action, the drive control unit 38 may drive the vibrating portions 26 with the maximum amount of vibration. Thus, the occupant can be warned in advance that the emergency driving action will be executed.

When the actual acceleration of the mobile object 1 becomes zero, the drive control unit 38 stops driving the vibrating portion 26. That is, the conditions for ending the driving of the vibrating portion 26 are based on the actual acceleration of the mobile object 1. The condition for terminating the driving of the vibrating portion 26 may be satisfied when a predetermined period of time has elapsed since the driving of the vibrating portion 26 was started. Further, the condition for terminating the drive of the vibrating portion 26 may be satisfied when the acceleration predicted by the prediction unit 36 is predicted to be equal to or less than a predetermined value.

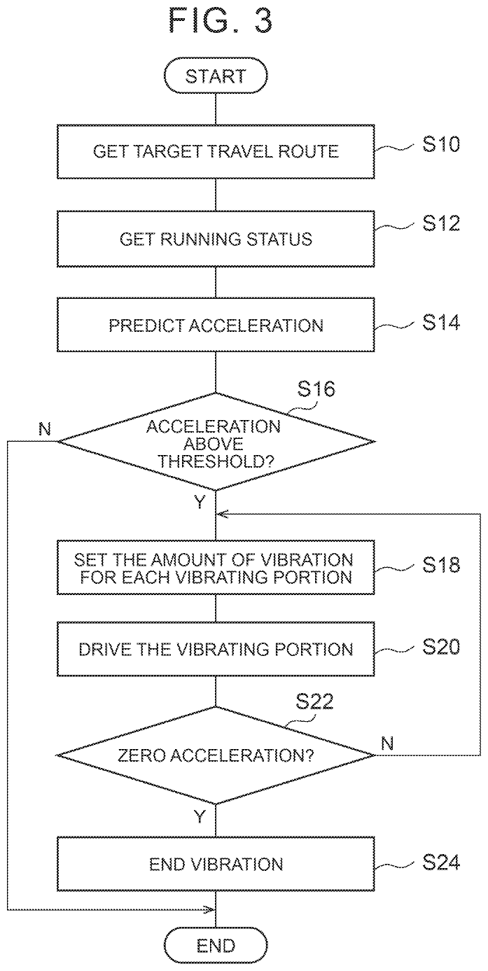

FIG. 3 is a flowchart of vibration generation processing for driving the vibrating portion 26 to inform the passenger of the operation of the mobile object 1. This vibration generation process is periodically executed. The route setting unit 32 sets a target travel route. The prediction unit 36 acquires the set target travel route (S10).

The prediction unit 36 acquires the running state information as the detection result of the mounted sensor 28 (S12). The prediction unit 36 predicts future acceleration that will occur in the mobile object 1 based on the target travel route and the travel state information (S14).

The drive control unit 38 determines whether the acceleration predicted by the prediction unit 36 is greater than or equal to a predetermined threshold (S16). If the predicted acceleration is smaller than the predetermined threshold (N of S16), the mobile object control system 10 ends this process without driving the vibrating portion 26.

If the predicted acceleration is equal to or greater than the predetermined threshold (Y in S16), the drive control unit 38 determines to drive the vibrating portion 26, and adjusts the vibration amount of each vibrating portion 26 according to the magnitude and direction of the acceleration. Set (S18). The drive control unit 38 starts driving the vibrating portion 26 with the set vibration amount (S20).

The drive control unit 38 determines whether the actual acceleration of the mobile object 1 is zero (S22). If the actual acceleration of the mobile object 1 is not zero (N of S22), the drive control unit 38 continues driving the vibrating portion 26. If the actual acceleration of the mobile object 1 is zero (Y of S22), the drive control unit 38 stops driving the vibrating portion 26 and ends this process.

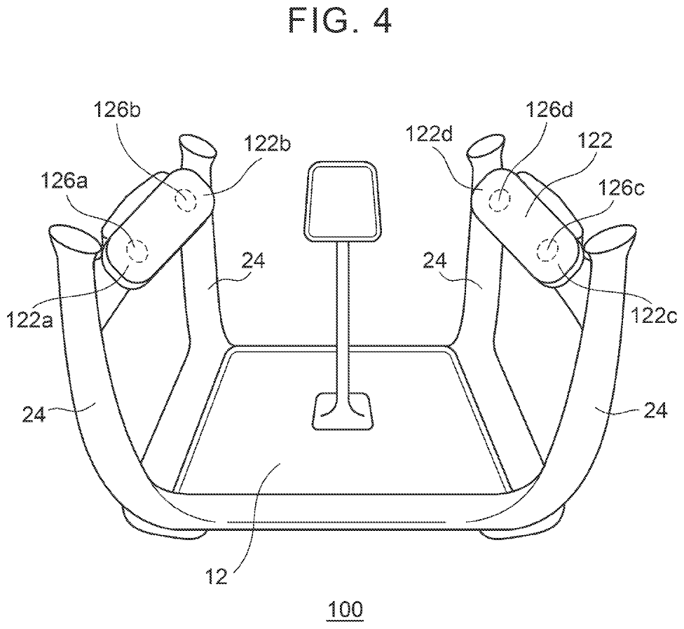

FIG. 4 is a perspective view of a mobile object 100 of a modified example. The mobile object 100 of the modified example differs from the mobile object 1 shown in FIG. 1A in the arrangement of the first backrest portion 122a, the second backrest portion 122b, the third backrest portion 122c, and the fourth backrest portion 122d. The configuration of the mobile object control system 10 other than their arrangement is the same.

A first vibrating portion 126a, a second vibrating portion 126b, a third vibrating portion 126c and a fourth vibrating portion 126d (when these are not distinguished, they will be referred to as “vibrating portion 126”) are provided in the first backrest portion 122a, the second backrest portion 122b, the third backrest portion 122c, and the fourth backrest portion 122d, respectively.

The first backrest portion 122a and the second backrest portion 122b are arranged side by side in the lateral direction on the front side of the mobile object 100. The third backrest portion 122c and the fourth backrest portion 122d are arranged side by side in the lateral direction on the rear side of the mobile object 100. The first backrest portion 122a and the second backrest portion 122b, and the third backrest portion 122c and the fourth backrest portion 122d are arranged facing each other in the longitudinal direction. Therefore, the occupants ride facing each other.

The drive control unit 38 varies the vibration amounts of the plurality of vibrating portions 126 according to the direction and magnitude of the predicted acceleration. For example, when the mobile object 100 stops, the occupant is accelerated forward. At this time, the drive control unit 38 makes the vibration amounts of the third vibrating portion 126c and the fourth vibrating portion 126d on the rear side larger than the vibration amounts of the first vibrating portion 126a and the second vibrating portion 126b on the front side. Also, when the mobile object 100 starts running, the occupant is accelerated backward. At this time, the drive control unit 38 makes the vibration amounts of the first vibrating portion 126a and the second vibrating portion 126b on the front side larger than the vibration amounts of the third vibrating portion 126c and the fourth vibrating portion 126d on the rear side.

In addition, an Example is an illustration to the last. It should be understood by those skilled in the art that various modifications can be made to the combination of each component, and such modifications are within the scope of the present disclosure.

In the embodiment, the mode in which the mobile object 1 carries four passengers is shown, but it is not limited to this mode. For example, it may be for two people or for three people. For two people, the backrest portions 22 are arranged side by side in the front and rear direction, or arranged side by side in the left and right direction.

What is claimed is:

1. A mobile object control system comprising:
a plurality of backrest portions configured to support backs of occupants riding on a mobile object and arranged in a lateral direction or a longitudinal direction;
a plurality of vibrating portions provided for the individual backrest portions;
a prediction unit configured to predict an acceleration expected to occur in the mobile object in a future; and
a drive control unit configured to drive the vibrating portions before the predicted acceleration occurs, wherein the drive control unit is configured to vary vibration amounts of the vibrating portions based on the predicted acceleration.

2. The mobile object control system according to claim 1, wherein:
the prediction unit is configured to predict the acceleration of the mobile object in the future based on a target travel route of the mobile object and a speed of the mobile object; and
the drive control unit is configured to vary the vibration amounts of the vibrating portions based on a direction and a magnitude of the predicted acceleration.

3. The mobile object control system according to claim 1, wherein:
the backrest portions are arranged in the lateral direction; and
the drive control unit is configured to, when a direction of the predicted acceleration is a rightward direction, set the vibration amount of the vibrating portion positioned on a left side to be larger than the vibration amount of the vibrating portion positioned on a right side and, when the direction of the predicted acceleration is a leftward direction, set the vibration amount of the vibrating portion positioned on the right side to be larger than the vibration amount of the vibrating portion positioned on the left side.

4. The mobile object control system according to claim 3, wherein:
the mobile object has no door;
the backrest portions arranged at right and left are provided apart from each other at front and rear; and
the drive control unit is configured to vary the vibration amounts of the vibrating portions at the front and the rear based on the direction of the predicted acceleration.

5. A mobile object control method for controlling a mobile object including a plurality of backrest portions configured to support backs of occupants riding on the mobile object and arranged in a lateral direction or a longitudinal direction, and a plurality of vibrating portions provided for the individual backrest portions, the mobile object control method comprising:
a step of predicting an acceleration expected to occur in the mobile object in a future; and
a step of driving the vibrating portions before the predicted acceleration occurs, wherein the step of driving includes varying vibration amounts of the vibrating portions based on the predicted acceleration.
